(19) United States
(12) Patent Application Publication
(10) Pub. No.: US 2009/0116671 A1
(43) Pub. Date: May 7, 2009

(54) Remotely activated earpiece with radio and masking functions

(76) Inventors: Christian Barwick, Ogden, UT (US); Niki Lynn Woodward-Barwick, Ogden, UT (US)

Correspondence Address: Christian Barwick, 2359 North 1225 East, Ogden, UT, 84414, US

(21) Appl. No.: 11/982,713

(22) Filed: Nov. 5, 2007

(51) Int. Cl. H04R 25/00

(52) U.S. Cl. 381/315

(57) ABSTRACT

A remotely activated ear mounted control device and a method for performing the same comprising an earpiece adapted to fit in an ear; said earpiece having circuit and control components for receiving and transmitting signals from a remote control device to control one or more earpiece functions and an amplifier in said earpiece; said earpiece further comprising a power source to power said circuit and control components and said amplifier; and a control device remotely engaging said earpiece and said circuit and control components. The earpiece further comprising: one or more earpiece functions being an alarm function; or one or more earpiece functions being a tinnitus mask.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable.

### BACKGROUND OF THE INVENTION

1. Field of the Invention

The present invention relates to ear pieces. More particularly, the present invention relates to ear pieces with specially adapted internal controls accessible from a remote control and for effecting auditory alarm and masking signals.

2. Description of Related Prior Art

Sleeping aids and devices for assisting sleepers in waking up are not uncommon. Current earpieces and hearing aids come equipped with microphones, amplifiers for effecting various sounds, batteries, and volume control. Further embodiments include:

Previous devices U.S. Utility Pat. No. 7,126,485 discloses a sleep prevention device which includes an earpiece assembly having an alarm member that receives signals from a base station.

U.S. Utility Pat. No. 6,989,744 discloses an infant monitoring system which includes an ear insert capable of generating an audible alert.

U.S. Utility Pat. No. 6,906,983 discloses an ear plug alarm which has a separate setting device.

U.S. Utility Pat. No. 5,894,455 discloses an alarm clock system which includes an ear insert.

U.S. Utility Pat. No. 4,821,247 discloses a personal alarm clock which fits within or behind the ear of a user for alerting the user to a preset time.

U.S. Utility Pat. No. 5,886,952 discloses an alarm clock system which includes a remote control.

U.S. Utility Pat. No. 6,714,136 discloses an alarm clock which includes a remote control function.

United States Design Patent DES 430,673 illustrates a design for an ear piece.

What is not disclosed is an ear piece which can also serve to function as a radio or a tinnitus masker and that can be controlled by a remote control and not be dependent on a base station or central hub for emitting radio signals and signals for setting off alarms in an internal ear piece.

### SUMMARY OF THE INVENTION

A completely internal radio and/or alarm on an internal earpiece is desirable to avoid the problems related with the prior art of having to have a separate base radio component. Further, and in order to accommodate a completely internal radio and alarm in the earpiece, a remote control can be adapted to control the functions of the earpiece.

Therefore, one object of the present invention is to provide an ear mounted control system comprising an earpiece adapted to fit in an ear, with embedded circuits and controls for receiving and converting radio signals from a remote control to an amplifier in the earpiece; and the earpiece further comprising a removable power source.

Another object is to provide an ear mounted control system further comprising an alarm function in the earpiece operatively engaging the circuits and controls for transmitting an alarm to the amplifier in the earpiece.

Another object is to provide an ear mounted control system further comprising a remote control operatively engaging a receiver in the earpiece that converts wireless signals into specified functions from the user to the control system.

Another object is to provide a remote control that transmits infrared signals and an earpiece receiver that converts infrared signals.

Another object is to provide a remote control that comprises a display for viewing the status of radio functions.

### BRIEF DESCRIPTION OF THE DRAWINGS

FIG. 1 is a perspective view of an earpiece with aperture for inserting a battery and a separate remote control.

FIG. 2 is an illustration of a remote control device with a display screen having preferred alarm/radio/masker settings.

FIG. 3 is a logical flow diagram of the functions of an earpiece radio showing the execution of radio processes for a specified function.

### DETAILED DESCRIPTION OF THE DRAWINGS AND PREFERRED EMBODIMENTS

A complete understanding of this invention can be gained through reference to the drawings in conjunction with a thorough review of the disclosure herein.

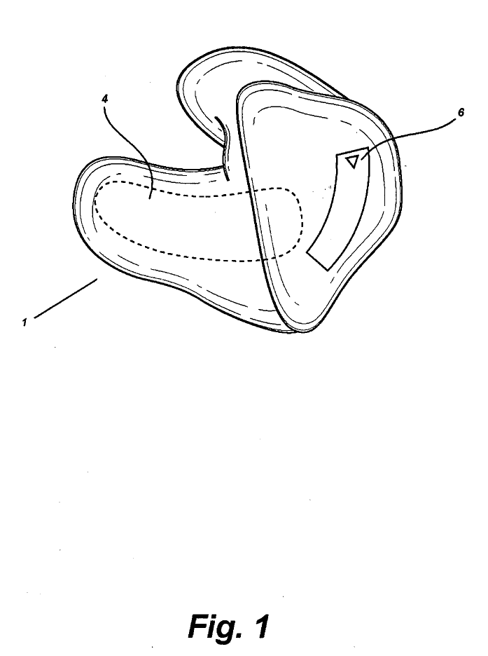

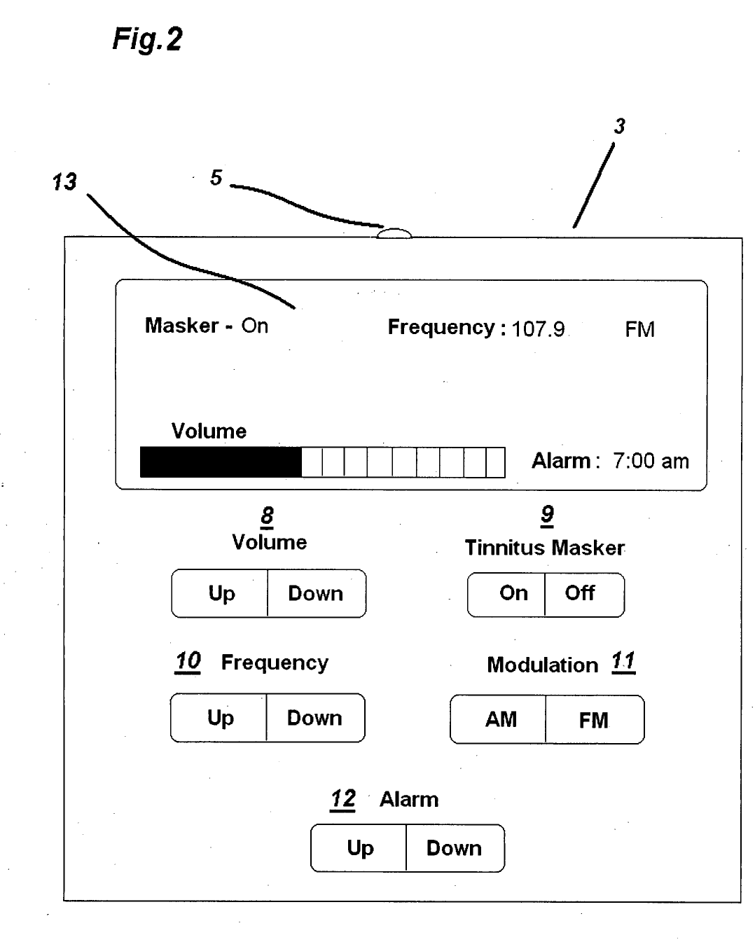

What is disclosed is a novel earpiece with an internal radio, alarm clock, and tinnitus masker with functions that can be externally controlled and displayed by a remote control 3. Earpiece 1 shown in FIG. 1 is an ear device that can be either generally shaped or specially fitted for insertion in a person's ear. Earpiece 1 has one or more apertures for inserting and removing batteries 2 or other removable power sources, or for sending and receiving signals transmitted to and from a remote control 3. (FIG. 2) Further, earpiece 1 can be formed of plastic or other composite material that can be glued, fitted, or otherwise secured together for later repair.

Internal to earpiece 1 is a microcontroller 4 on a miniature integrated circuit with controllers for performing various functions and programmed using known techniques. Printed circuit boards can be made according to known configurations and in accordance with the cited art referenced provided by Applicant, (such as that found in United States Patent Nos. 4,539,708, and 3,826,987) and incorporated herein by reference. Processes for creating an internal processor and integrated circuit currently exist wherein the components and circuits can be formed from a ceramic base with layers of conductive and insulating material. Conducting layers can be gold, copper, or silver and the insulating layer silicone compounds. The electric components can be connected with wires as small as 0.025 mm thick.

Preferred modulation for the circuit earpiece is done through frequency modulation (FM) because of strength of signal, although amplitude modulation (AM) or both are acceptable. The preferred frequency range is standard frequency modulation in the range of 87.5 to 108 Mhz and using standard demodulation techniques. Frequencies can be received through an internal antenna to the ear insert, and wherein the user's body can act as a boost. One type of antennae that can be used is found in U.S. Pat. No. 4,123,756 and incorporated herein by reference.

A remote control 3 device is a novel means of providing a person who travels with a device for setting and controlling the controls and functions of the earpiece 1 without having to rely on a base station or central receiver for the alarm and other settings as is done in the art. As shown in FIG. 2, it is preferred, and for reasons of economy, an infrared emitter 5 such as an LED capable of sending light signals to an infrared receiver 6 on the earpiece 1 are used to control the functions of the invention. However, it is also acceptable to use other signaling techniques such as radio and/or proprietary signals such as BlueTooth.

A remote control 3 of the present invention such as that shown in FIG. 2 is operated by assigning a command (typically a binary one) to a designated function of a command component—in this case an earpiece. (See, for example U.S. Pat. No. 4,746,919) A button on the remote control actuates a contact on an integrated circuit (not shown) of the remote control for that function which is sent as an electrical signal to an LED that, in turn, transmits that signal to an infrared or similar wireless signal to a corresponding receiver on a command component. The command component receiver then converts the wireless signal to an electrical signal sent to a microprocessor that actuates the command. Engaging the microprocessor is non-volatile memory that can store the commands and any other settings preferred by the user.

The remote control 3 device should also be able to perform setting changes to the internal earpiece. For example, FIG. 2 shows volume settings 8, tinnitus mask setting 9, frequency settings 10, modulation settings 11, alarm settings 12, and a display 13 for visual ease of use.

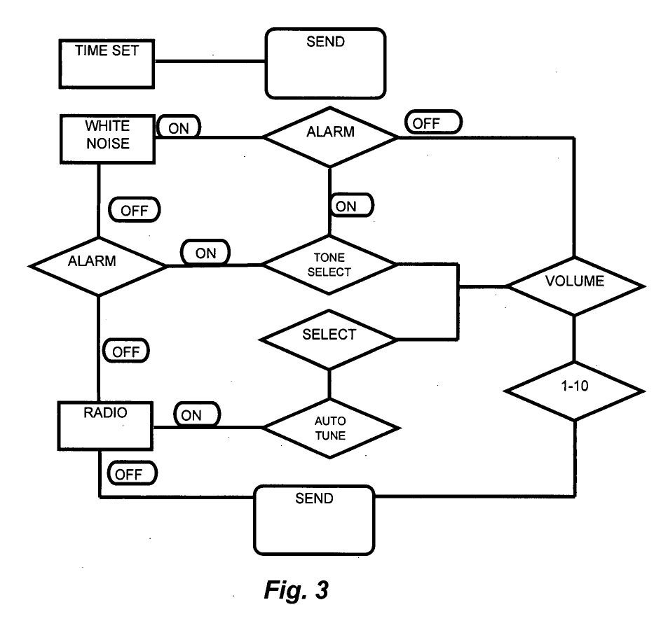

FIG. 3 shows as an illustration but not as a limitation, a logical flow diagram for setting either an alarm, tinnitus masker, or radio function from a remote control 3 where either one of the tinnitus mask, frequency, modulation, or alarm functions may be chosen as preferred user settings.

Adequate amplification devices are also known in the art however, a preferred frequency should be between 250 and 9,000 Hz for optimal sound conditions and without causing damage to a person's ear.

As stated above, remote control 3 preferably uses infrared signals to transmit data to a receiver on earpiece 1. Remote control 3 also should have the desired functionality of controlling alarm, tinnitus masker settings, and radio settings including tuning and volume controls. This is best accomplished by incorporating a visual display 13 such as a liquid crystal that can include a backlit or similar display type for visually queuing the user as to the desired functions.

As a portable power source for the earpiece, a portable battery such as a 1.4v micro-battery (not shown) can be inserted and removed from earpiece 1 when the battery power is discharged. Those in the art will also appreciate that alternate types of portable power sources can also be applied including rechargeable batteries and other types of recharging devices can be applied to power the invention. Also, providing power through alternate or direct current may also be used.

An important and novel component of the present invention is to provide audible masking capabilities 9 to earpiece 1 to mask constant noise stemming from tinnitus. As one of the desired functions of earpiece, an auditory control function 9 can be set remotely to create an auditory signal amplified from earpiece. The auditory signal should be a relatively constant amplified adjustable signal in the range of 40-85 decibals and with a frequency range of 500-1000 hz although those skilled in the art will appreciate that modifications can be made to adjust these ranges based on a preferred signal and according to preferences for individual users.

Although the above provides a description of the various novelties of the invention, the above disclosures do not represent all of the embodiments of the present invention. Those skilled in the art will appreciate many other ancillary embodiments and equivalents that naturally flow from the disclosures contained herein.

We claim:

1. A remotely activated ear mounted control device comprising:
an earpiece adapted to fit in an ear;
said earpiece having circuit and control means for receiving and transmitting signals from a remote control device to control one or more earpiece functions and an amplifier in said earpiece;
said earpiece further comprising a power source to power said circuit and control means and said amplifier; and
a control device remotely engaging said earpiece and said circuit and control means.

2. The ear mounted control system of claim 1 wherein said one of said one or more earpiece functions is an alarm function.

3. The ear mounted control system of claim 1 wherein said one of said one or more earpiece functions is a tinnitus mask function.

4. A method for remotely activating an ear mounted control device comprising:
adapting an earpiece to contain embedded circuit and control means for receiving and transmitting radio signals to control one or more earpiece functions and an amplifier;
Incorporating a power source into said earpiece to power said circuit and control means and said amplifier; and
remotely engaging said amplifier, circuit and control means and said earpiece functions through a remote control device.

5. The method of claim 4 further comprises adapting said earpiece to further comprise an alarm function as one of said earpiece functions and operatively engaging said amplifier.

6. The method of claim 4 further comprises adapting said earpiece to further comprise a tinnitus mask function and operatively engaging said amplifier.
